(19) United States
(12) Patent Application Publication
(10) Pub. No.: US 2024/0403126 A1
(43) Pub. Date: Dec. 5, 2024

(54) SMART INTERRUPT CONTROLLER

(71) Applicant: XILINX, INC., San Jose, CA (US)

(72) Inventors: Karthikeyan THANGAVEL, Erode (IN); Anil Kumar MAMIDALA, Hyderabad (IN); Yashwant DAGAR, Mahendergarh (IN); Mohammad Rafi SHAIK, Kodad (IN)

(21) Appl. No.: 18/204,251

(22) Filed: May 31, 2023

(51) Int. Cl. G06F 9/50; G06F 13/24

(52) U.S. Cl. CPC G06F 9/5038; G06F 9/5044; G06F 13/24

(57) ABSTRACT

A smart interrupt controller (SIC) routs an interrupt to a specific processor by dynamically changing the affinity of the interrupt based upon the processor power state and/or system load thereof. The SIC arbitrates interrupt servicing based on various parameters such as interrupt priority, interrupt affinity, processor load and processor power. Interrupt load sharing between selected processors increases overall computer system performance. Interrupt latency times decrease by avoiding unnecessary switching of processor power states from an inactive state to an active state by instead routing the interrupt to a different processor already in an active state. Interrupt latency times will decrease by routing the interrupt service request from a heavily loaded processor to one that is not so heavily loaded. Whereby active processor clock cycles are effectively utilized for interrupt servicing. Overall computer system power requirements will be reduced by eliminating unnecessary waking up of an inactive (sleeping) processor.

### TECHNICAL FIELD

Embodiments of the present disclosure generally relate to computer systems having a plurality of central processing units (CPUs) or a plurality of digital processing cores of at least one CPU, and in particular, to a smart interrupt controller to improve the performance and reduce power consumption of the computer systems when servicing interrupts from peripheral devices.

### BACKGROUND

Current computer systems use a plurality of central processing units (CPUs) or a plurality of digital processing cores of at least one CPU (hereinafter collectively “processors”) for running programs in a multitasking fashion which provides for increased computational power in handling, manipulating and transferring data. The processors are assisted in their tasks through peripheral devices such as memory controllers, communications interfaces, graphics processors, disk controllers and the like. Peripheral devices, as such, are asynchronous in operation and use interrupts to request service from a processor to assist in an intended operation of the peripheral device, e.g., reading and writing data to a storage disk, communications to other computer systems, graphical and user interfaces, etc. A processor, individually or in combination with other processors, may also be configured to have a plurality of digital processing cores or “cores.”

In large scale integrated circuit computer systems, e.g., System-On-Chip (SoC) architectures, a plurality of central processing units (processors) are integrated with interrupt control and logic to work in combination with a plurality of peripheral devices. These peripheral devices enhance, enable and provide for different functions and applications for the processors. Each SoC processor may comprise a plurality of digital processing cores.

### SUMMARY

In one example of the disclosure, an apparatus includes a smart interrupt controller (SIC) adapted for coupling to a plurality of peripherals for receiving interrupt requests (IRQs) therefrom and to a plurality of processors for directing the IRQs to selected ones of the plurality of processors, the SIC comprising. A plurality of storage registers for storing information about the plurality of peripherals and the plurality of processors. Interrupt routing control logic adapted for coupling the IRQs from the plurality of peripherals to the plurality of processors. Wherein the SIC selects ones of the plurality of processors to process the IRQs from the plurality of peripherals based on information about the plurality of peripherals and the plurality of processors.

In one example of the disclosure, a method for receiving an interrupt request (IRQ) from a peripheral having an affined processor designated, and in response to a power state of the affined processor being in an active mode and an operating load of the affined CPU being less than a load threshold for the affined processor, then routing the IRQ to the affined processor. In response to the power state of the affined processor being in the active mode and the operating load of the affined processor being equal to or greater than the load threshold for the affined processor, or in response to the power state of the affined processor being in a low power mode, then routing the IRQ to an active next processor whose operating load is less than a load threshold for the active next processor.

In one example of the disclosure, a method for receiving an interrupt request (IRQ) from a peripheral in response to an operating load of a least loaded processor of a plurality of processors being less than a load threshold, then routing the IRQ to the least loaded CPU.

### BRIEF DESCRIPTION OF THE DRAWINGS

So that the manner in which the above recited features of the present invention can be understood in detail, a more particular description of the invention, briefly summarized above, may be had by reference to examples, some of which are illustrated in the appended drawings. It is to be noted, however, that the appended drawings illustrate only typical examples of this invention and are therefore not to be considered limiting of its scope, for the invention may admit to other equally effective examples.

FIG. 1 illustrates a schematic block diagram of a computer system comprising a plurality of central processing units (processors), according to an example.

FIG. 1A illustrates a schematic block diagram of a computer system comprising at least one central processing unit (processor) having a plurality of digital processing cores, according to an example.

FIG. 2 illustrates a schematic block diagram of a smart interrupt controller (SIC) coupling interrupt requests to a plurality of central processing units (processors), according to an example.

FIG. 2A illustrates a schematic block diagram of a smart interrupt controller (SIC) coupling interrupt requests to at least one central processing unit (processor) having a plurality of digital processing cores, according to an example.

FIG. 3 illustrates interrupt priority and processor status tables, according to an example.

FIG. 3A illustrates interrupt priority and core status tables, according to an example.

FIG. 4 illustrates a schematic process flow diagram for a smart interrupt controller (SIC), according to an example.

FIG. 5 illustrates a schematic process flow diagram for a smart interrupt controller (SIC), according to another example.

FIG. 6 illustrates a schematic process flow diagram for a smart interrupt controller (SIC), according to yet another example.

FIG. 7 illustrates tables of energy savings for different numbers of operating processors/cores and operating loads thereof, according to examples.

FIG. 8 illustrates a schematic graph of power consumption reductions using the smart interrupt controller (SIC) with different numbers of operational processors, according to examples.

To facilitate understanding, identical reference numerals have been used, where possible, to designate identical elements that are common to the figures, and a lower-case letter added where the elements are substantially the same. It is contemplated that elements of one embodiment may be beneficially incorporated in other embodiments.

### DETAILED DESCRIPTION

In existing computer systems, each peripheral device will use an asynchronous/synchronous interrupt mechanism to request processor and/or core resource time to perform a specific task in combination with the requesting peripheral device. There may be ‘N’ number of possible interrupts in the computer system which cannot be handled alone by only one processor/core. There needs to be a specific interrupt controller to multiplex those interrupt requests into a smaller set of interrupt requests to at least one of the plurality of processors/cores to handle all these interrupts from any master/slave peripheral devices in the computer system. Assertion of interrupts may be asynchronous or synchronous, and there is a possibility that all peripheral devices in the computer system can trigger interrupts. There may also be synchronous interrupts raised by software to perform a specific task. Each interrupt can be identified using an interrupt identification “INTRID” by an interrupt controller (handler). In a modern SoC there may be multiple processors/cores and the interrupt controller has to route the interrupt to a specific processor/core having an affinity for that interrupt from an associated peripheral device or from software. A SoC may also comprise one or more processors, each of the one or more processors may comprise a plurality of digital processing cores.

Generally, an interrupt (from a peripheral device) is assigned to a specific processor/core (affinity) during computer system configuration. When a peripheral device requires servicing (assistance with a specific task) by a processor/core, it will issue an interrupt request and then has to wait until the specific processor/core resource is available. Peripheral device interrupt servicing time by an affined processor/core varies with the computation and data transfer loading of the processor/core. In a multiprocessor (processor) computing system, one or more processors may be in a low power (“sleep”) mode to conserve computer system power. Whereby when a processor in a sleep mode receives an interrupt request it must “wake-up” and return to a normal functional mode of operation to service the interrupt. The same is true in a computer system having at least one processor having a plurality of digital processing cores.

There are multiple levels in routing the interrupts from interrupt source, e.g., peripheral device, to a processor/core having an affinity for the device issuing that interrupt. Each peripheral device can enable or disable a particular interrupt therefrom. The interrupt controller may also be able to mask or unmask a particular interrupt. A processor/core may also disable or enable interrupts globally. When multiple interrupts reach the interrupt controller, at substantially the same time, the interrupt controller can arbitrate and route an interrupt to a specific processor/core having an affinity for the peripheral device associated with that interrupt.

During computer system peripheral configuration, interrupt handlers will be registered (entered) for each associated interrupt. The interrupt entries may be updated in an interrupt vector table of the interrupt controller. Once an interrupt reaches a processor/core, the processor/core will switch to an interrupt mode and fetch the associated interrupt handler from the vector table. The processor/core may then use instructions from the fetched interrupt handler to process the interrupt and then clear an interrupt flag.

When an asynchronous interrupt from a peripheral is received by the interrupt controller, the interrupt controller will prioritize the received interrupts, and by default, will route the received interrupts to a master processor (processor0), irrespective of what the load is of that processor and/or its power state. In the case of when the interrupt controller has interrupt affinity support, then it will route that interrupt to the corresponding affined processor-x, irrespective of that processor load and/or power state. Present interrupt controllers do not have the knowledge of processor loads and power states in distributing the interrupts across the processors in the SoC or computer system.

By default, when all the interrupts will be handled by the master processor (processor0) and the master processor0 is heavily loaded, system sluggishness will be observed. For the processor affinity case, the interrupt will be handled by that particular affined processor-x, irrespective of that processor-x's processing load and/or power state. When a selected processor is in a low power state, it will add additional latency time to bring back up that processor to an active state for processing the interrupt. In a similar fashion, a computer system having at least one processor with a plurality of digital processing cores will route an interrupt to a pre-affined core irrespective of operating load or power state status of that core.

Some disadvantages of the aforementioned interrupt processing are, for example but are not limited to: 1) Interrupt latency will be longer in time, if an affined processor/core has to come out of a low power state, to service the interrupt. 2) When a particular processor/core is heavily loaded and any affined interrupt to the same processor/core asserts an interrupt request, the system will become sluggish. 3) When a processor-x/core-x is in a low power state and processor-y/core-y is in an active state, if the interrupt is directed to processor-x/core-x, this interrupt will wake up the affined processor-x/core-x which will thereby consume more power. 4) An active processor/core (with less computational load) clock cycles are wasted, by waking up the affined processor/core while in a low power state.

According to examples of this disclosure, a smart interrupt controller (SIC) routes an interrupt to a specific processor/core by dynamically changing the affinity of the interrupt based upon the processor/core power state and/or processor/core load thereof. Doing so reduces overall computer system power consumption and increases the computer system performance. According to advantages of the examples of this disclosure, the smart interrupt controller (SIC) arbitrates interrupts based on various parameters, for example but not limited to: interrupt priority, interrupt affinity, processor/core load and processor/core power state to effectively save system power and improve the performance of the computer system (SoC). The SIC effectively allows handling of a plurality of interrupts by load sharing the interrupts requiring servicing between selected processors/cores of the SoC (computer system). This interrupt load sharing between the selected processors/cores increases overall computer system performance. Interrupt latency times will decrease by avoiding unnecessary switching of processor/core power states from an inactive (sleeping) state to an active state by instead routing the interrupt to a different processor/core already in an active (wakeup) state. Interrupt latency times will decrease by routing the interrupt service request from a heavily loaded processor/core to one that is not so heavily loaded. Whereby active processor/core clock cycles are effectively utilized for interrupt servicing. Overall computer system power requirements will be reduced by eliminating unnecessary waking up of an inactive (sleeping) processor/core.

Various features are described hereinafter with reference to the drawing figures. It should be noted that the drawing figures may or may not be drawn to scale and that the elements of similar structures or functions are represented by like reference numerals throughout the drawing figures. It should be noted that the drawing figures are only intended to facilitate the description of the features of the examples. They are not intended as an exhaustive description of the examples below or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described. Referring now to the drawing figures, the details of examples are schematically illustrated. Like elements in the drawing figures will be represented by like numbers, and similar elements will be represented by like numbers with a different lower-case letter suffix.

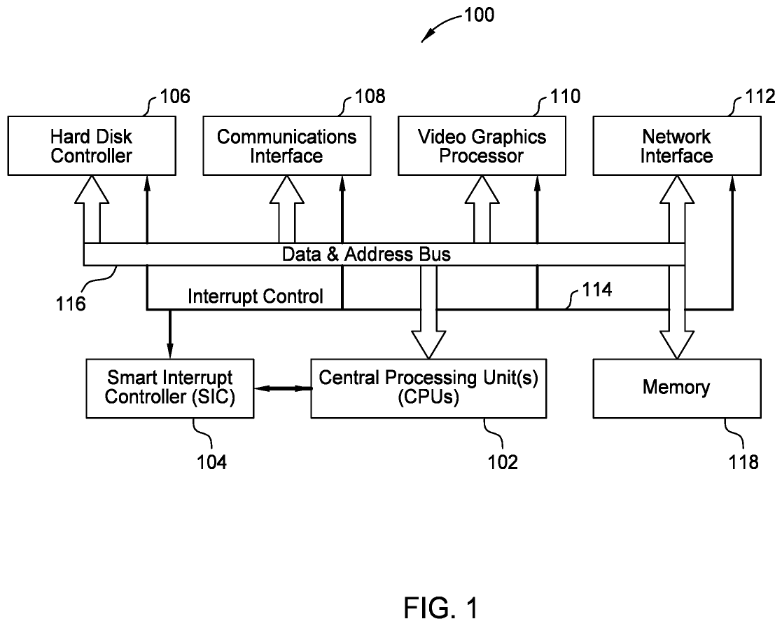

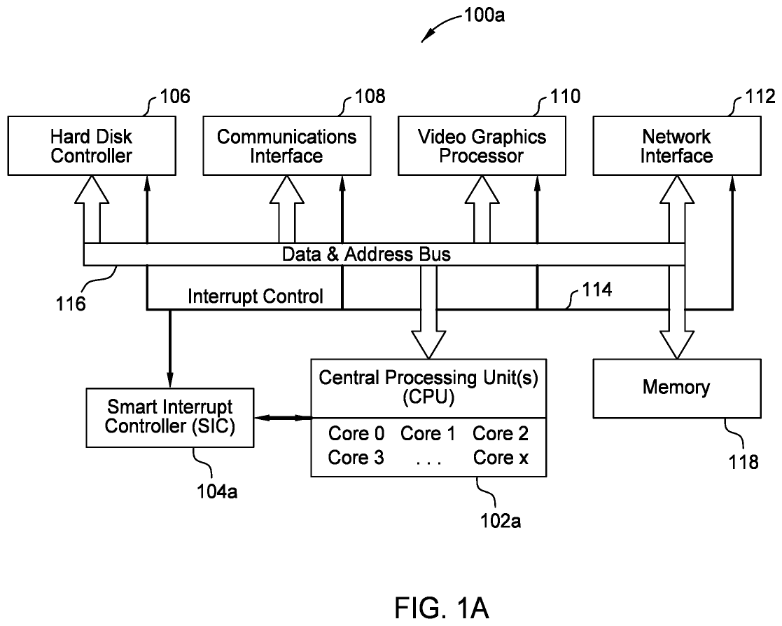

Referring to FIG. 1, depicted is a schematic block diagram of a computer system comprising a plurality of central processing units (processors), according to an example. A computer system, generally represented by the numeral 100, may comprise a plurality of central processing units (processors) 102, a memory 118 coupled to the plurality of processors 102, a smart interrupt controller (SIC) 104, a plurality of peripheral devices, for example but is not limited to: a hard disk controller 106. a commutations interface 108, video graphics processor 110, a network interface 112 and other compute units (not shown). Interrupt control bus 114 may couple the smart interrupt controller 104 to the plurality of peripheral device interrupt request lines, and a data and address bus 116 couple data and address information between the processors 102 and the plurality of peripheral devices.

Referring to FIG. 1A, depicted is a schematic block diagram of a computer system comprising at least one central processing unit (processor) having a plurality of digital processing cores, according to an example. A computer system, generally represented by the numeral 100a, may comprise at least one central processing unit (processor) 102a having a plurality of digital processing cores (cores 0 . . . x), a memory 118 coupled to the at least one processor 102a, a smart interrupt controller (SIC) 104a, a plurality of peripheral devices, for example but is not limited to: a hard disk controller 106. a commutations interface 108, video graphics processor 110, a network interface 112 and other compute units (not shown). Interrupt control bus 114 may couple the smart interrupt controller 104a to the plurality of peripheral device interrupt request lines, and a data and address bus 116 couple data and address information between the at least processor 102a having the plurality of digital processing cores and the plurality of peripheral devices.

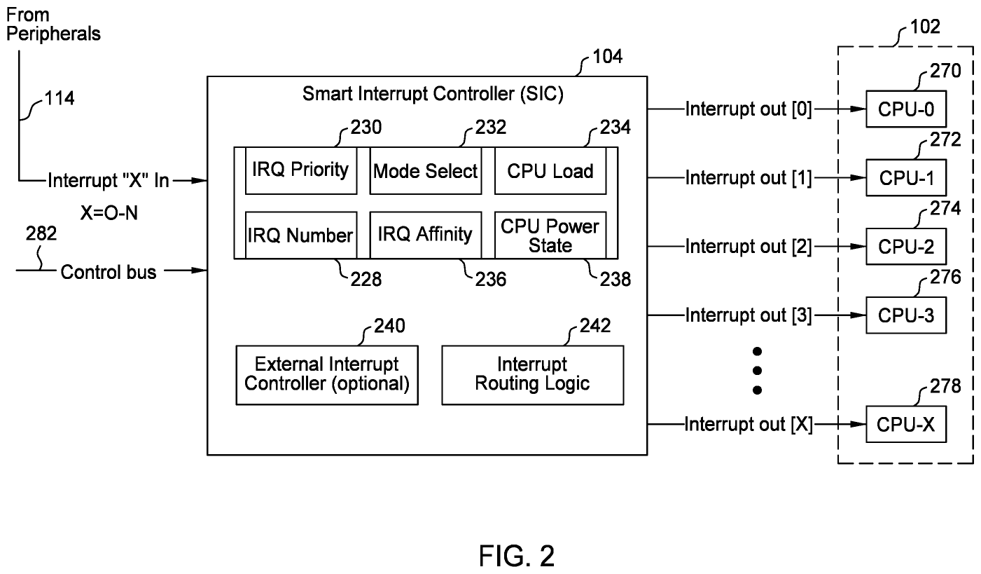

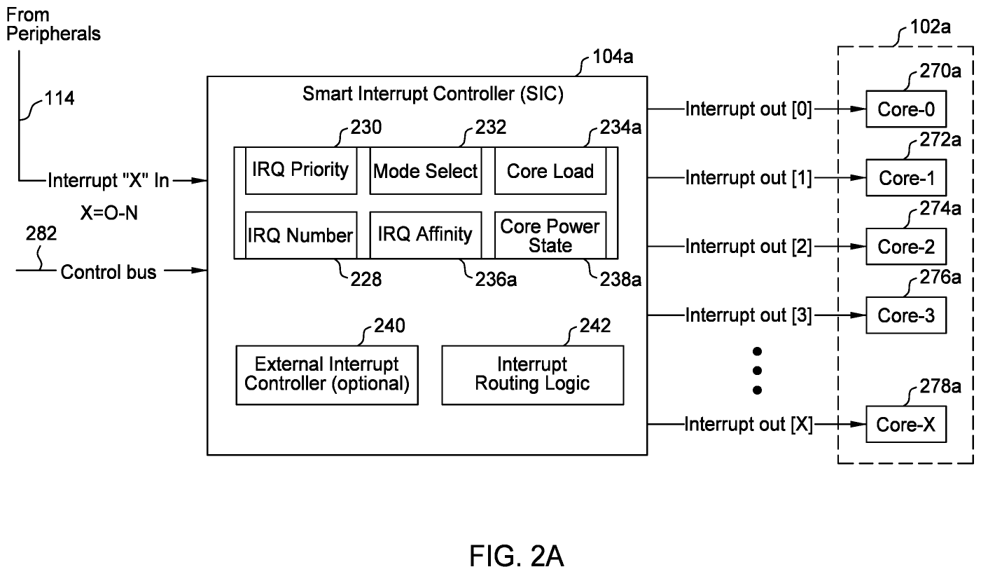

Referring to FIG. 2, depicted is a schematic block diagram of a smart interrupt controller (SIC) coupling interrupt requests to a plurality of central processing units (processors), according to an example. The SIC 104 receives interrupt requests on the interrupt control bus 114 from a plurality of peripheral devices (FIG. 1). The SIC 104 directs these interrupt requests to selected ones of the plurality of processors 102 for maximizing computer system performance and/or reducing power consumption thereof. The SIC 104 may also direct interrupt requests based upon other computer system 100 requirements such as, for example but not limited to, power and performance. Upon computer system operational initialization or at any time during operation thereof, registers of the SIC 104 may be programmed with desired relationships between the plurality of peripheral devices and the plurality of processors 102, e.g., each peripheral interrupt request having an affinity to one of the plurality of processors 102, and interrupt request priority relationships (determining which interrupt should be serviced before another is serviced when both interrupt requests occur at substantially the same time).

The SIC 104 may comprise, but is not limited to, peripheral interrupt request (IRQ) number registers 228, IRQ priority registers 230, a mode select register 232, processor load registers 234, IRQ affinity registers 236, and processor power state registers 238. Interrupt routing logic 242 is provided, and external interrupt control 240 may be optionally provided. A computer system 100 startup/configuration program may be used, over the control bus 282, to configure the IRQ number registers 228, IRQ priority registers 230, mode select registers 232, IRQ affinity registers 236, and/or external interrupt control 240. The interrupt routing logic 242 provides for interrupt request control routing between a processor 102 selected by the SIC 104 for the peripheral requesting interrupt service. The processor load registers 234 store the real time computational loads of each operating processor 102. The processor power state registers 238 store the power states of the plurality of processors 102, e.g., active power state (operational) or low power state (sleep or standby). The mode select registers 232 store the operating modes of the SIC 104, e.g., disabled, enabled-1, enabled-2, enabled-3.

The interrupt control bus 114 may have all the interrupt requests from the plurality of peripherals concatenated. Optionally, depending upon the total number of interrupts from the peripherals, interrupt requests may be handled with a plurality of interrupt controllers, e.g., advanced extensible interface (AXI) Interrupt controllers, that may be instantiated by the SIC 104 in its software/hardware wrapper. Interrupt requests from the AXI interrupt controllers may be routed on the interrupt outputs of the SIC 104 by the interrupt routing logic 242 to each one of the plurality of processors 102 (interrupt output lines are shown to match the number of processors 270, 272, 274, 276 and . . . and 278). The affinity of the Interrupt lines may be symmetrically divided between the plurality of processors 102, making one interrupt routed to each one of the plurality of processors 102 by default. However, it is contemplated and within the scope of this disclosure that interrupt routing may be dynamically configurable based upon user preferences. Also based upon computer system 100 requirements, the SIC 104 may be enabled or disabled during software configuration and/or operation (e.g., programmed into the mode select register 232). It is contemplated and within the scope of this disclosure that interrupts and peripherals may be accommodated by any number of processors 102, according to the teachings of this disclosure.

Referring to FIG. 2A, depicted is a schematic block diagram of a smart interrupt controller (SIC) coupling interrupt requests to at least one central processing unit (processor) having a plurality of digital processing cores, according to an example. The SIC 104a receives interrupt requests on the interrupt control bus 114 from a plurality of peripheral devices (FIG. 1A). The SIC 104a directs these interrupt requests to selected ones of the plurality of digital processing cores 270a to 278a of the at least one processor 102a for maximizing computer system performance and/or reducing power consumption thereof. The SIC 104a may also direct interrupt requests based upon other computer system 100a requirements such as, for example but not limited to, power and performance. Upon computer system operational initialization or at any time during operation thereof, registers of the SIC 104a may be programmed with desired relationships between the plurality of peripheral devices and the plurality of digital processing cores 270a to 278a, e.g., each peripheral interrupt request having an affinity to one of the plurality of digital processing cores 270a to 278a, and interrupt request priority relationships (determining which interrupt should be serviced before another is serviced when both interrupt requests occur at substantially the same time).

The SIC 104a may comprise, but is not limited to, peripheral interrupt request (IRQ) number registers 228, IRQ priority registers 230, a mode select register 232, core load registers 234a, IRQ affinity registers 236a, and core power state registers 238a. Interrupt routing logic 242 is provided, and external interrupt control 240 may be optionally provided. A computer system 100a startup/configuration program may be used, over the control bus 282, to configure the IRQ number registers 228, IRQ priority registers 230, mode select registers 232, IRQ affinity registers 236a, and/or external interrupt control 240. The interrupt routing logic 242 provides for interrupt request control routing between a core selected by the SIC 104a for the peripheral requesting interrupt service. The core load registers 234a store the real time computational loads of each operating core 270a to 278a of the at least one processor 102a. The core power state registers 238a store the power states of the plurality of cores 270a to 278a, e.g., active power state (operational) or low power state (sleep or standby). The mode select registers 232 store the operating modes of the SIC 104a, e.g., disabled, enabled-1, enabled-2, enabled-3.

The interrupt control bus 114 may have all the interrupt requests from the plurality of peripherals concatenated. Optionally, depending upon the total number of interrupts from the peripherals, interrupt requests may be handled with a plurality of interrupt controllers, e.g., advanced extensible interface (AXI) Interrupt controllers, that may be instantiated by the SIC 104a in its software/hardware wrapper. Interrupt requests from the AXI interrupt controllers may be routed on the interrupt outputs of the SIC 104a by the interrupt routing logic 242 to each one of the plurality of cores 270a to 278a (interrupt output lines are shown to match the number of cores 270a, 272a, 274a, 276a . . . and 278a). The affinity of the Interrupt lines may be symmetrically divided between the plurality of the cores 270a to 278a of the at least one processor 102a, making one interrupt routed to each one of the plurality of cores 270a to 278a by default. However, it is contemplated and within the scope of this disclosure that interrupt routing may be dynamically configurable based upon user preferences. Also based upon computer system 100a requirements, the SIC 104a may be enabled or disabled during software configuration and/or operation (e.g., programmed into the mode select register 232). It is contemplated and within the scope of this disclosure that interrupts and peripherals may be accommodated by any number of cores 270a to 278a of the at least one processor 102a, according to the teachings of this disclosure.

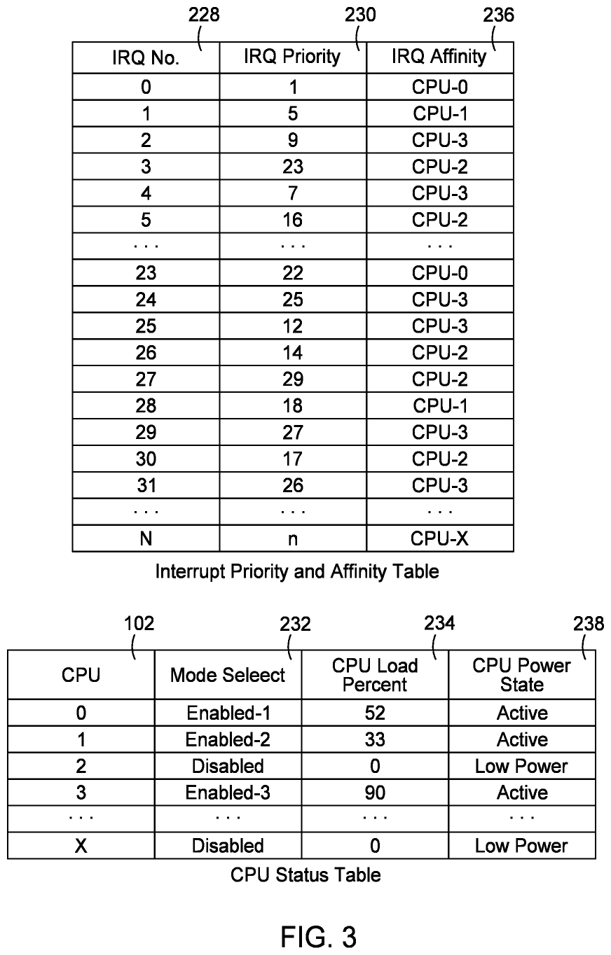

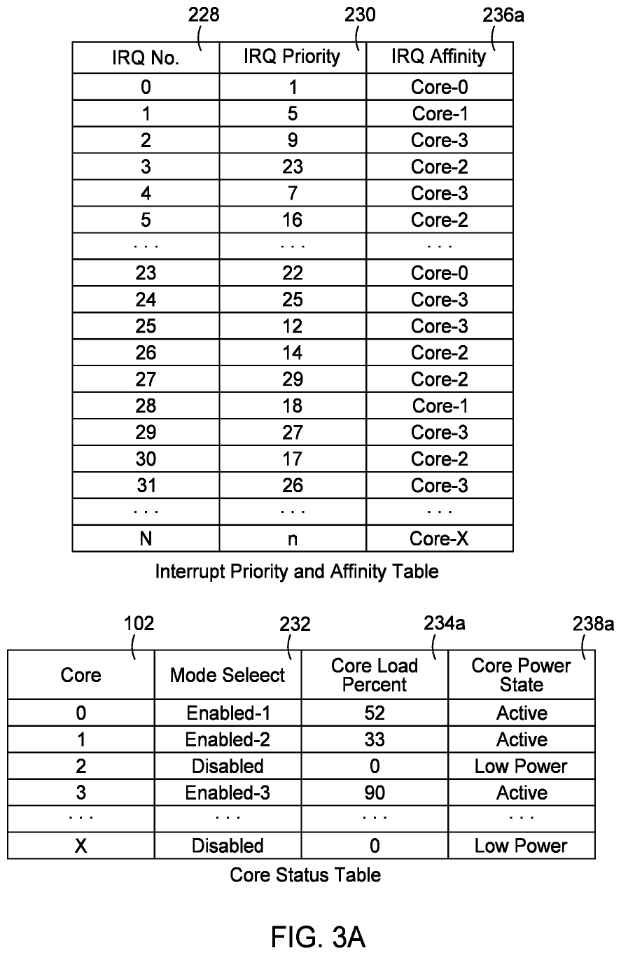

Referring to FIG. 3, depicted are interrupt priority and processor status tables, according to an example. Values for an interrupt priority and affinity table may be configured by storing (programming via the control bus 282) the necessary information parameters into the peripheral interrupt request (IRQ) number registers 228, the IRQ priority registers 230 and the IRQ affinity registers 236. The SIC 104 may then use the interrupt priority and affinity table register values in priority selection of an interrupt request and pairing it with the best processor 102 option to handle the interrupt request.

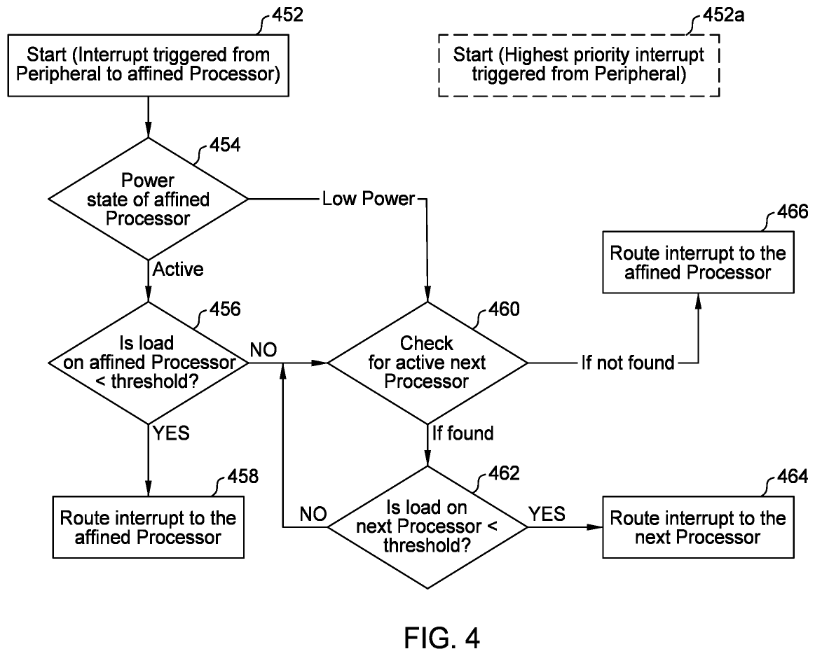

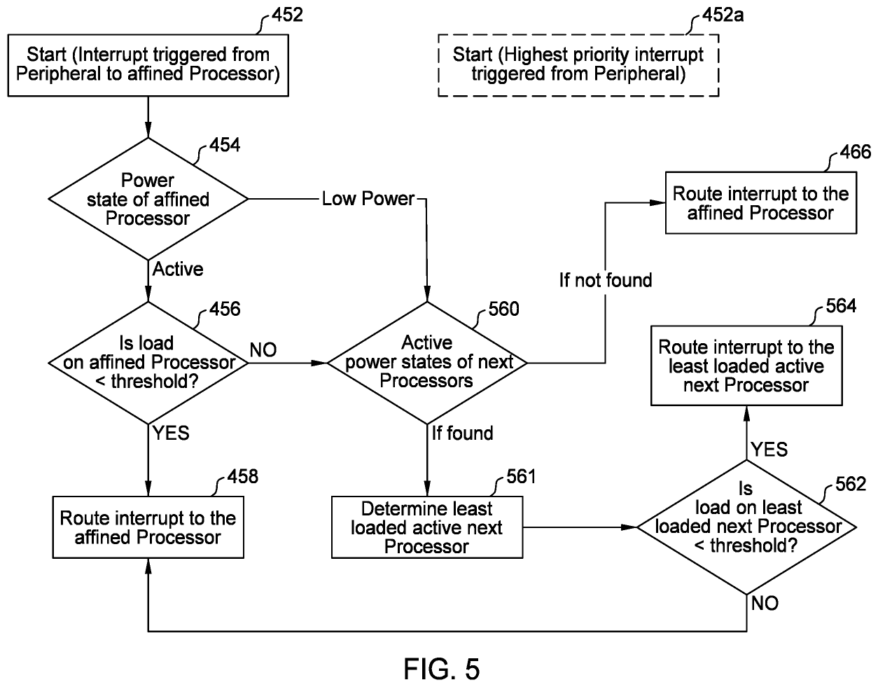

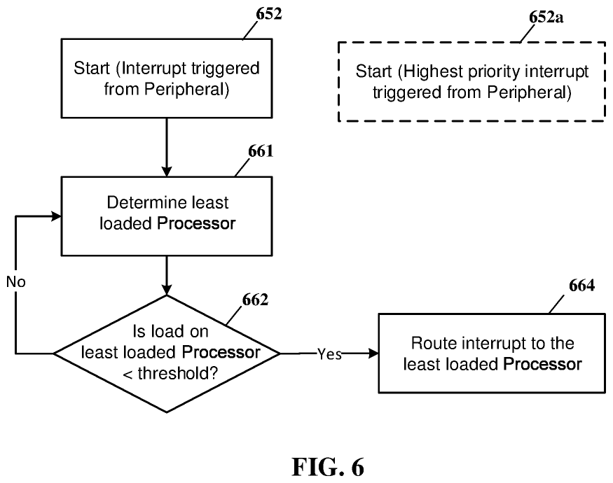

The SIC 104 can also factor in various possibilities for selection of a processor 102 by considering the values stored in the processor Status Table of each processor power state and percentage of operating load. Therefore, the SIC 104 can make an optimal decision of which processor 102 should handle an interrupt request (IRQ) based upon its processor affinity, processor power state and processor load percent. Note more than one IRQ has been affined with a processor, and based on the IRQ priority and IRQ affinity will be serviced by an affined processor, or in the alternative, by another processor as explained in the process flow diagrams of FIGS. 4, 5 and 6. The mode select registers 232 may store the operating relationship of the SIC 104 to each processor 102 For example: in mode “disabled” the SIC 104 operates as a standard interrupt controller, in mode “enabled-1” the SIC 104 operates according to the process flow diagram of FIG. 4, in mode “enabled-2” the SIC 104 operates according to the process flow diagram of FIG. 5, and in mode “enabled-3” the SIC 104 operates according to the process flow diagram of FIG. 6.

Referring to FIG. 3A, depicted are interrupt priority and core status tables, according to an example. Values for an interrupt priority and affinity table may be configured by storing (programming via the control bus 282) the necessary information parameters into the peripheral interrupt request (IRQ) number registers 228, the IRQ priority registers 230 and the IRQ affinity registers 236a. The SIC 104a may then use the interrupt priority and affinity table register values in priority selection of an interrupt request and pairing it with the best core option of the at least one processor 102a to handle the interrupt request.

The SIC 104a can also factor in various possibilities for selection of a core of the at least one processor 102a by considering the values stored in the Core Status Table of each core power state and percentage of operating load. Therefore, the SIC 104a can make an optimal decision of which core of the at least one processor 102a should handle an interrupt request (IRQ) based upon its core affinity, core power state and core load percent. Note more than one IRQ has been affined with a core, and based on the IRQ priority and IRQ affinity will be serviced by an affined core, or in the alternative, by another core as explained in the process flow diagrams of FIGS. 4, 5 and 6. The mode select registers 232 may store the operating relationship of the SIC 104a to each core of the at least one processor 102a. For example: in mode “disabled” the SIC 104a operates as a standard interrupt controller, in mode “enabled-1” the SIC 104a operates according to the process flow diagram of FIG. 4, in mode “enabled-2” the SIC 104a operates according to the process flow diagram of FIG. 5, and in mode “enabled-3” the SIC 104a operates according to the process flow diagram of FIG. 6.

Referring to FIG. 4, depicted is a schematic process flow diagram for a smart interrupt controller (SIC), according to an example. Hereinafter “processor” will be understood to represent “processor 104” or “core 270a-278a of the at least one processor 104a,” “SIC” will be understood to represent “SIC 104” or “SIC 104a,” wherein processor will be used in the descriptions of process elements of FIGS. 4-6. A processor may be selected by the SIC to service an interrupt request by a peripheral based upon the parameters in the aforementioned interrupt priority and affinity table, and the processor/core status tables (FIG. 3 or 3A).

In step 452 an interrupt request (IRQ) is triggered from a peripheral to an affined processor. This IRQ has a number and from that IRQ number, an affined processor is determined from the Interrupt Priority and Affinity Table (FIG. 3 or 3A). Alternatively, in step 452a, when substantially simultaneous interrupt requests (IRQs) from a plurality of peripherals are received, each affined with the same processor, the highest priority interrupt request received will be serviced first and subsequent lower priority, in descending order of priority, will be subsequently serviced.

In step 454 a power state of the affined processor is determined. If the power state of the affined processor is in an active mode, then in step 456 the current processing load of the affined processor is compared to a load threshold. If the current processing load is less than the load threshold, then in step 458 the interrupt request (IRQ) is routed to the affined processor. After which the affined processor handles the interrupt request (IRQ).

In step 454, if the power state of the affined processor is in a low power mode, then in step 460 availability of an active next processor is determined. If no active next processors are found then in step 466 the interrupt request (IRQ) is routed back to the original affined processor and the interrupt request (IRQ) must wait to be serviced until the original affined processor is available. The interrupt request (IRQ) may also be routed to an active next processor when one becomes available (not shown on flow diagram).

If an active next processor is found in step 460 then the load on that active next processor is compared to a load threshold in step 462. If the load on the active next processor is less than the load threshold then in step 464 the interrupt request (IRQ) is routed to the active next processor for handling. If the load on the active next processor is greater than or equal to the load threshold then step 460 continues checking for another active next processor until in step 462 a load on the another active next processor is less than the load threshold. Then in step 464 the interrupt request (IRQ) is routed to the another active next processor for handling. The load threshold may be, for example but is not limited to, 40 to 70 percent of processor operating capacity.

Referring to FIG. 5, depicted is a schematic process flow diagram for a smart interrupt controller (SIC), according to another example. A processor may be selected by the SIC to service an interrupt request by a peripheral based upon the parameters in the aforementioned interrupt priority and affinity table, and the processor/Core status table (FIG. 3 or 3A).

In step 452 an interrupt request (IRQ) is triggered from a peripheral to an affined processor. This IRQ has a number and from that IRQ number, the affined processor is determined from the Interrupt Priority and Affinity Table (FIG. 3 or 3A). Alternatively, in step 452a, when substantially simultaneous interrupt requests (IRQs) from a plurality of peripherals are received, each affined with the same processor, the highest priority interrupt request (IRQ) received will be serviced first and subsequent lower priority, in descending order of priority, will be subsequently serviced.

In step 454 a power state of the affined processor is determined. If the power state of the affined processor is in an active mode, then in step 456 the current processing load of the affined processor is compared to a load threshold. If the current processing load is less than the load threshold, then in step 458 the interrupt request (IRQ) is routed to the affined processor. After which the affined processor handles the interrupt request (IRQ).

In step 454, if the power state of the affined processor is in a low power mode, then in step 460 the availability of an active next processor is determined. If no active next processors are found then in step 466 the interrupt request (IRQ) is routed back to the original affined processor and the interrupt request (IRQ) must wait to be serviced until the original affined processor is available. The interrupt request (IRQ) may also be routed to an active next processor when one becomes available (not shown on flow diagram).

If active next processors are found in step 460 then in step 461 a one of the active next processors having the lowest load is compared to a load threshold in step 462. If the load on the one of the active next processors is less than the load threshold then in step 464 the interrupt request (IRQ) is routed to the least loaded one of active next processors for handling. However, in step 462, if there are no next processors running at a load less than the load threshold, then in step 458, the interrupt request (IRQ) is routed to the affined processor. The load threshold may be, for example but is not limited to, 40 to 70 percent of processor operating capacity.

Referring to FIG. 6, depicted is a schematic process flow diagram for a smart interrupt controller (SIC), according to yet another example. A processor may be selected by the SIC to service an interrupt request by a peripheral based upon the parameters in the aforementioned interrupt priority and affinity table, and the processor status table (FIG. 3 or 3A).

In step 652 an interrupt request (IRQ) is triggered from a peripheral. Alternatively, in step 652a, when substantially simultaneous interrupt requests (IRQs) from a plurality of peripherals are received, the highest priority interrupt request received will be serviced first and subsequent lower priority, in descending order of priority, will be subsequently serviced.

In step 661 a least loaded processor is determined. Then in step 662, the least loaded processor is compared to a load threshold. If the load on the least loaded processor is less than the load threshold then then in step 664 the interrupt request (IRQ) is routed to the least loaded processor for handling.

In step 662, if the load on the least loaded processor is greater than or equal to the load threshold then step 661 continues checking for another least loaded processor until in step 662 a load on the another least loaded processor is less than the load threshold. Then in step 664 the interrupt request (IRQ) is routed to the another least loaded processor for handling. The load threshold may be, for example but is not limited to, 40 to 70 percent of processor operating capacity.

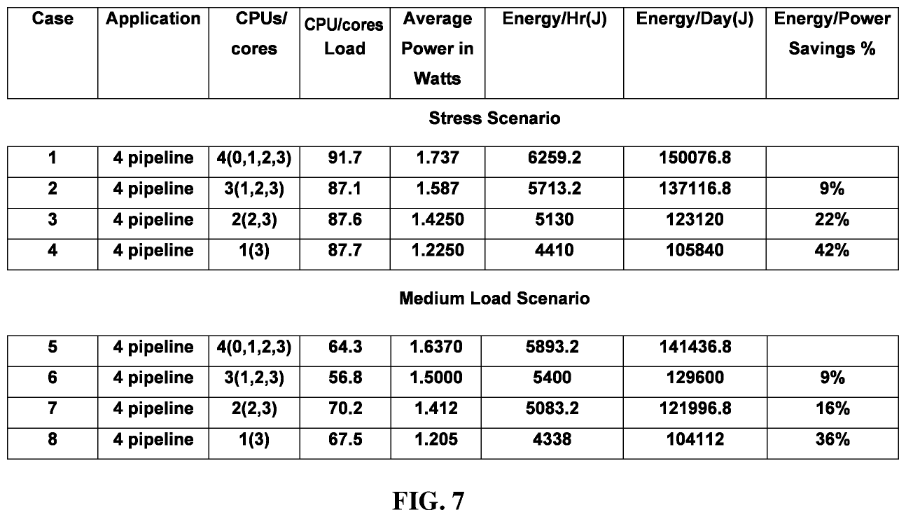

Referring to FIG. 7, depicted are tables of energy savings for different numbers of operating processors and operating loads thereof, according to examples. Example power savings are shown in the table of FIG. 7 when the SIC is operating for selection of processors servicing interrupt requests. For all cases there are four pipelines active (interrupts from multiple peripherals requesting service). In cases 1 and 5 all processors are enabled and operating to service the interrupt requests, so there is no energy/power savings. In cases 2 and 6 three processors are active to service the interrupt requests, so there is a modest energy/power savings since one processor remains disabled. In cases 3 and 7 two processors are active to service the interrupt requests, so there is more energy/power savings since two processors remain disabled. In cases 4 and 8 only one processor is active to service the interrupt requests, so there is the most energy/power savings since the processors remain disabled. Not having to enable a processor(s) saves computer system energy/power.

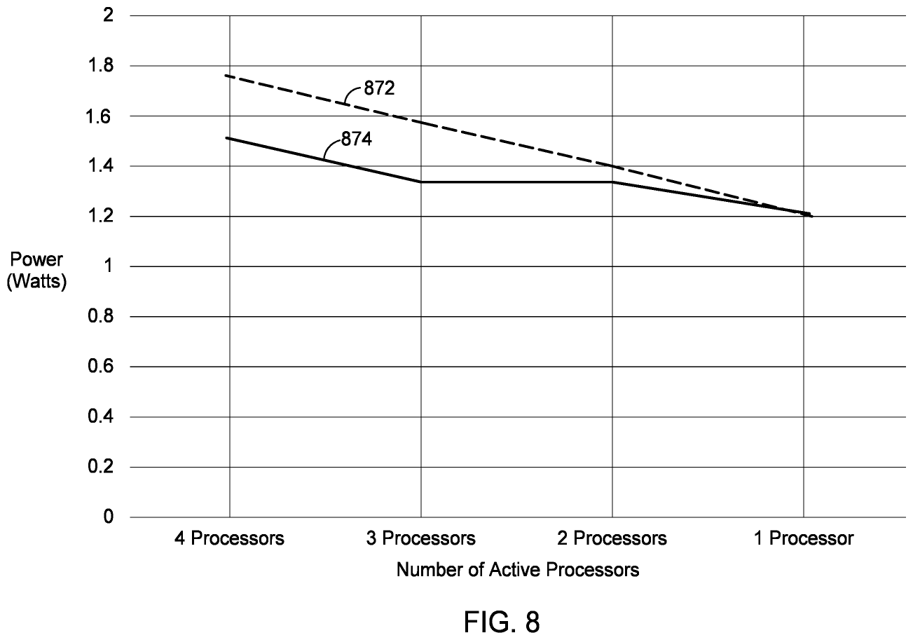

Referring to FIG. 8, depicted is a schematic graph of power consumption reductions using the smart interrupt controller (SIC) with different numbers of operational processors, according to examples. Graph line 872 represents computer system power consumption when using a standard interrupt controller not having access to the processor operating state and loading. Graph line 874 represents computer system power consumption when using the smart interrupt controller (SIC), according to the teachings of this disclosure. Using either standard or smart interrupt controllers with only one active processor, energy/power consumption of the computer system remains the same. As more processors become active, energy/power consumption decreases when using the SIC since disabled processors need not be enabled unless computer system processing requirements have to use more processor(s) for data processing. Also, less process loaded processors may be better utilized in servicing interrupt requests (IRQ).

As will be appreciated by one skilled in the art and having the benefit of this disclosure, the embodiments disclosed herein may be embodied as a system, method, apparatus, or computer programmed product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

While the foregoing is directed to embodiments of the present invention, other and further embodiments of the invention may be devised without departing from the basic scope thereof, and the scope thereof is determined by the claims that follow.

What is claimed is:

1. An apparatus, comprising:
a smart interrupt controller (SIC) adapted for coupling to a plurality of peripherals for receiving interrupt requests (IRQs) therefrom and to a plurality of processors for directing the IRQs to selected ones of the plurality of processors, the SIC comprising:
a plurality of storage registers for storing information about the plurality of peripherals and the plurality of processors; and
interrupt routing control logic adapted for coupling the IRQs from the plurality of peripherals to the plurality of processors;
wherein the SIC selects ones of the plurality of processors to process the IRQs from the plurality of peripherals based on information about the plurality of peripherals and the plurality of processors.

2. The apparatus according to claim 1, wherein
the plurality of storage registers are selected from the group consisting of:
processor load registers for storing operating load information from each of the plurality of processors,
processor power state registers for storing whether each of the plurality of processors is in an enabled mode or a disabled mode,
IRQ number registers for storing interrupt numbers of each of the plurality of peripherals, and
IRQ affinity registers for storing affinities of each one of the plurality of peripherals to respective ones of the plurality of processors;
wherein when an IRQ is received from a peripheral the SIC will route the IRQ to an affined processor or to another one of the plurality of processors when the affined processor is not available.

3. The apparatus according to claim 2, wherein the affined processor is not available when its operating load is greater than a load threshold.

4. The apparatus according to claim 2, wherein the affined processor is not available when its power state is in a disabled mode.

5. The apparatus according to claim 2, wherein the plurality of storage registers further comprises IRQ priority registers for determining in what order the IRQs will be serviced when more than one IRQ is received by the SIC at substantially the same time.

6. The apparatus according to claim 2, wherein the plurality of storage registers further comprises mode select registers for determining operational characteristics of the SIC for each of the plurality of processors.

7. The apparatus according to claim 6, wherein the operational characteristics of the SIC are selected from the group consisting of:
manual selection of a processor to service the IRQ,
automatic selection of the affined processor or another active processor to service the IRQ,
automatic selection of the affined processor or a least loaded another active processor to service the IRQ, and
automatic selection of a least loaded processor to service the IRQ.

8. The apparatus according to claim 7, wherein the manual selection of the processor to service the IRQ is done with external interrupt control.

9. The apparatus according to claim 1, further comprising external interrupt control for routing the IRQs through the SIC.

10. The apparatus according to claim 1, wherein the IRQs from the plurality of peripherals are asynchronous.

11. The apparatus according to claim 1, wherein IRQs raised by software are synchronous.

12. The apparatus according to claim 1, wherein IRQ routing to an affined processor is dynamically configurable.

13. A method, comprising:
receiving an interrupt request (IRQ) from a peripheral having an affined processor designated; and
in response to a power state of the affined processor being in an active mode and an operating load of the affined CPU being less than a load threshold for the affined processor, routing the IRQ to the affined processor.

14. The method according to claim 13, further comprising:
in response to the power state of the affined processor being in the active mode and the operating load of the affined processor being equal to or greater than the load threshold for the affined processor, or in response to the power state of the affined processor being in a low power mode, routing the IRQ to an active next processor whose operating load is less than a load threshold for the active next processor.

15. The method according to claim 14, wherein the active next processor is a least loaded one of active next processors.

16. The method according to claim 14, when there is no active next processor, routing the IRQ to the affined processor.

17. The method according to claim 13, further comprising prioritizing servicing of a plurality of IRQs from respective ones of a plurality of peripherals.

18. The method according to claim 13, further comprising configuring routing of an IRQ dynamically to an affined processor.

19. A method, comprising:
receiving an interrupt request (IRQ) from a peripheral;
in response to an operating load of a least loaded processor of a plurality of processors being less than a load threshold, routing the IRQ to the least loaded CPU.

20. The method according to claim 19, further comprising prioritizing servicing of a plurality of IRQs from respective ones of a plurality of peripherals.
